(19) United States
(12) Patent Application Publication
(10) Pub. No.: US 2019/0077271 A1
(43) Pub. Date: Mar. 14, 2019

(54) ELECTRIC CHARGING SYSTEM FOR ELECTRIC CARS

(71) Applicant: SparkCharge, Inc., Syracuse, NY (US)

(72) Inventors: Joshua Christian AVIV, Syracuse, NY (US); Bryan Christopher MORRIS, Baldwinsville, NY (US)

(73) Assignee: SparkCharge, Inc., Syracuse, NY (US)

(21) Appl. No.: 16/126,494

(22) Filed: Sep. 10, 2018

Related U.S. Application Data
(60) Provisional application No. 62/556,041, filed on Sep. 8, 2017.

(51) Int. Cl. B60L 11/18

(52) U.S. Cl. CPC B60L 11/1818; B60L 11/1824

(57) ABSTRACT

An electric vehicle charging system includes a connector plug connectable to a connector base connected to a modular charging unit. The connector plug includes a plurality of connectors receivable in a plurality of openings of the connector base. A connector of the plurality of connectors includes an extending portion for contacting a terminal connector of the connector base. The connector plug and the connector base are rotatable relative to each other after the plurality of connectors are received in the plurality of openings such that the extending portion rotates to contact the terminal connector to provide an electrical connection between the modular charging unit and a load of an electric vehicle. The connector plug and the connector base are lockable relative to each other to inhibit movement therebetween after the extending portion contacts the terminal connector.

### TECHNICAL FIELD

The present invention relates to electric vehicles. More specifically, the invention relates to charging systems for electric vehicles

### BACKGROUND

Electric vehicles (EV) have a finite range that depends on the amount of electric charge stored in the EV's battery. Once battery charge in an EV is low, an operator, or user, of the EV must find a charging station, or charging unit, to recharge the battery in order to maintain mobility.

However, there are a limited number of stationary EV charging stations throughout any given territory. Further the distribution of such charging stations is not uniform. As such, EV users often have difficulty finding a stationary charging station during use of the EV. Therefore, the EV operators do not have the same freedom of movement as that of a gas driven vehicle, wherein gasoline refueling stations are located relatively evenly, and much more numerously, throughout the world than that of stationary EV charging stations.

Accordingly, there is a need for a way to re-charge an EV more conveniently and reliably during its use. Additionally there is a need to re-charge an electric vehicle even when a stationary charging station is not available.

### BRIEF DESCRIPTION

The present invention offers advantages and alternatives over the prior art by providing a portable electric charging system for electric vehicles (EVs). The charging system allows electric vehicle operators to charge anytime and place they want. For example, the portable charging system of the present invention may provide 15-20 miles of range and may charge the car at a rate of 1 mile every 60 seconds.

The charging system may be modular. Accordingly, EV owners may seamlessly connect and extend range by swapping out additional charging units of the charging system as they see fit. Further, the EV operators may store multiple charging units on board the EV.

The charging system may also be universal. Accordingly, the EV charging system may be able to charge all electric vehicles with Chademo or SAE Combo outlets. The charging system may also be recharged via a standard wall outlet or a solar panel system.

An electric vehicle charging system in accordance with one or more aspects of the present invention includes a connector plug connectable to a connector base connected to a modular charging unit. The connector plug includes a plurality of connectors receivable in a plurality of openings of the connector base. A connector of the plurality of connectors includes an extending portion for contacting a terminal connector of the connector base. The connector plug and the connector base are rotatable relative to each other after the plurality of connectors are received in the plurality of openings such that the extending portion rotates to contact the terminal connector to provide an electrical connection between the modular charging unit and a load of an electric vehicle. The connector plug and the connector base are lockable relative to each other to inhibit movement therebetween after the extending portion contacts the terminal connector.

### DRAWINGS

The invention will be more fully understood from the following detailed description taken in conjunction with the accompanying drawings, in which:

FIG. 1A depicts a perspective view of an example of a charging unit assembly of an electric charging system according to aspects described herein;

FIG. 1B depicts a perspective opposing view of an example of a charging unit assembly of an electric charging system according to aspects described herein;

FIG. 2A depicts a perspective assembled view of an example of a connector plug assembly of the electric charging system according to aspects described herein;

FIG. 2B depicts a perspective exploded view of an example of the connector plug assembly of FIG. 2A of the electric charging system according to aspects described herein;

FIG. 2C depicts a perspective expanded view of an example of the connector plug assembly within box A of the electric charging system according to aspects described herein;

FIG. 3A depicts a perspective exploded view of an example of a connector base assembly of the electric charging system according to aspects described herein;

FIG. 3B depicts a perspective assembled view of an example of the connector base assembly of FIG. 3A of the electric charging system according to aspects described herein;

FIG. 4 depicts a perspective view of an example of the electric charging system according to aspects described herein;

FIG. 5 depicts another perspective view of an example of the electric charging system according to aspects described herein; and

FIG. 6 depicts another perspective view of an example of the electric charging system according to aspects described herein;

### DETAILED DESCRIPTION

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The terms “substantially”, “approximately”, “about”, “relatively,” or other such similar terms that may be used throughout this disclosure, including the claims, are used to describe and account for small fluctuations, such as due to variations in processing. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

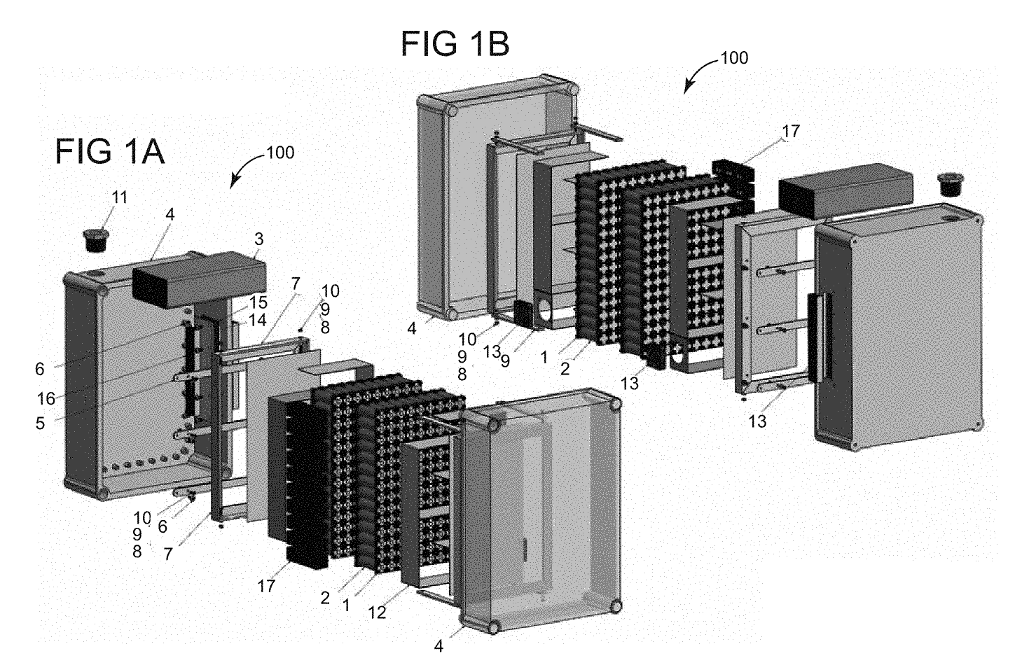

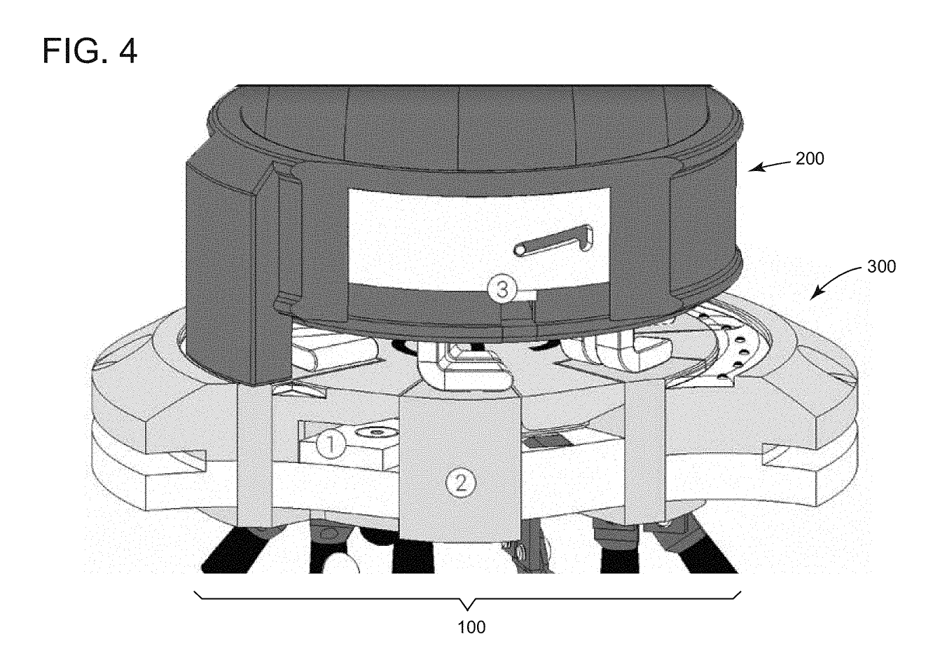

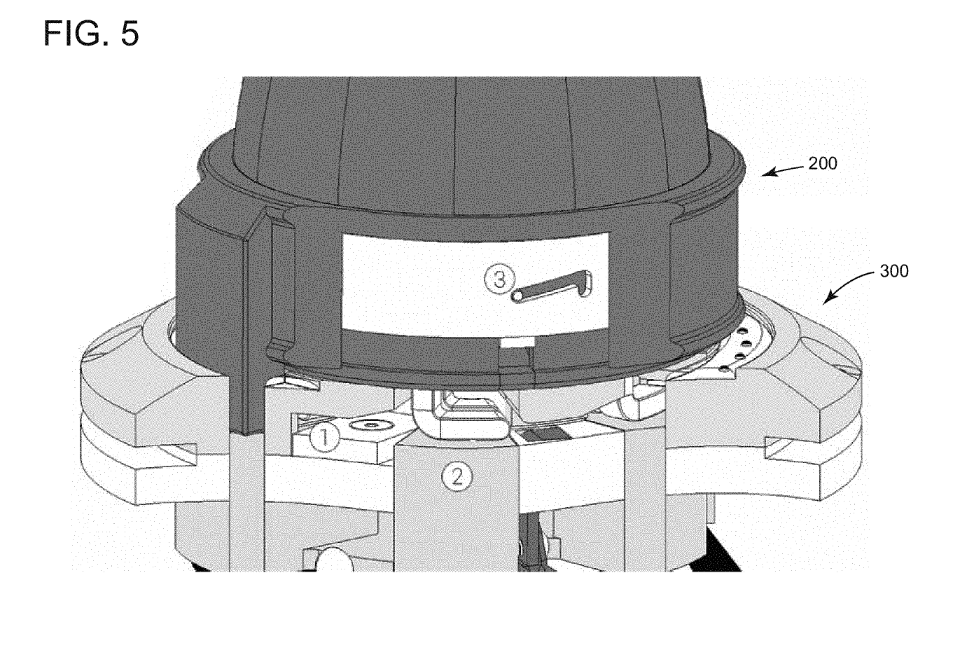

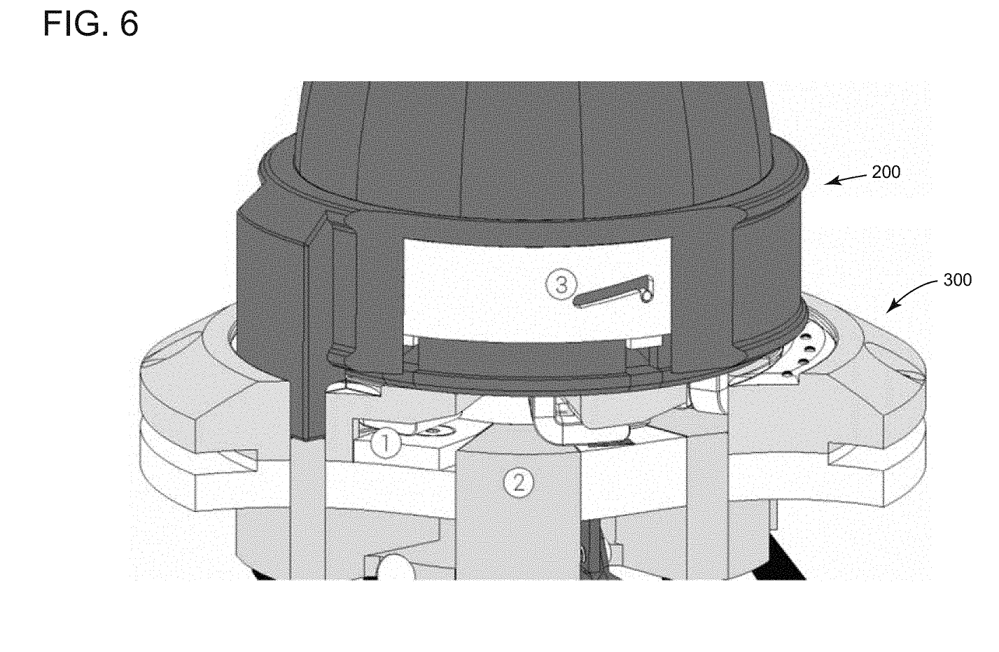

Referring to the FIGS. 1-6, examples of an electric charging system for electric vehicles (EVs) is presented in accordance with aspects herein. The charging system may include a charging unit 100, which may allow electric vehicle owners to charge their cars anytime and anywhere they want. The charging unit is powered by batteries, which may charge a car without being connected to any grid or external power source. The charging unit 100 may be a fast modular universal portable charging unit that may also be modular, wherein additional fast modular universal portable charging units can be connected and disconnected (i.e., substituted) during and after charging to give an electric vehicle more range. The charging unit 100 may be a fast charger, which may charge the car at industry standard level 3 speeds. The charging unit 100 may charge the EV at a rate of 1 mile every 60 seconds. The charging unit 100 may be universal, wherein it may work with any electric vehicle that has a Chademo & SAE Combo Plug.

In the examples of the electric charging system as illustrated in FIGS. 1-6, includes a charging unit assembly (or charging unit) 100 connected to a connector base assembly (or connector base) 300. The electric charging system also includes a connector plug assembly (or connector plug) 200 that is connectable to an EV and releasably connectable to the connector base assembly 300.

During use of the electric charging system, a user connects the connector plug assembly 200 to the connector base 300 and charging unit 100 by twisting and locking the connector plug 200 into the connector base 300. The user then turns on the charging unit 100 to transfer energy into the car. The car will automatically begin the charging sequence & pull energy out of the batteries 7 in the charging unit 100, which may be a modular portable charging unit. Once the charging unit 100 is depleted the charging will automatically stop. Once charging has stopped the user will twist and unlock the connector pug 200 from the connector base 300. The user will then swap or substitute in another charging unit 100. The user will commence charging by twisting and locking the connector plug 200 into the connector base 300 of the swapped in charging unit 100. The car will begin the charging sequence again and resume charging until the charging unit 100 is depleted. Once the desired charge has been met the user will unplug the charging unit 100 from the car and place the charging unit 100 in the vehicle or place of storage.

To charge the fast modular universal portable charging unit (FIG. 1), the user will plug the fast modular universal portable charging unit (FIG. 1) into any wall outlet and the fast modular universal portable charging unit (FIG. 1) will begin recharging its battery's.

Referring to FIGS. 1A and 1B, an example of the charging unit 100 is presented. The charging unit 100 may be a fast modular universal portable charging unit, which may include 18650 Battery Spacers, 18650 batteries, Polycarbonate Case, 3 battery case struts, M5 Thread-Forming Screws, Battery Frame, M3×0.5 Flat Head Screw, M3 Washer, M3×0.5 Nylon Locknut, Battery Cooling Air Flow Sheet, 40 mm DC Cooling Fan, Heat Exchanger Plate, Silicone Rubber Sheet, Aluminum Heat Exchanger, 40A SPDT (Form C) relays, 14S 30A Battery Mgmt. System, Nickel Strips, 3S Battery Management System, Resistor: 1800 Ohms, Resistor: 470 Ohms, NKK Switches SPST Toggle Switch, Littelfuse Fuse 40 A 80 V DC, Cree Schottky diode 4 A, charge controller, LM35 temperature sensor.

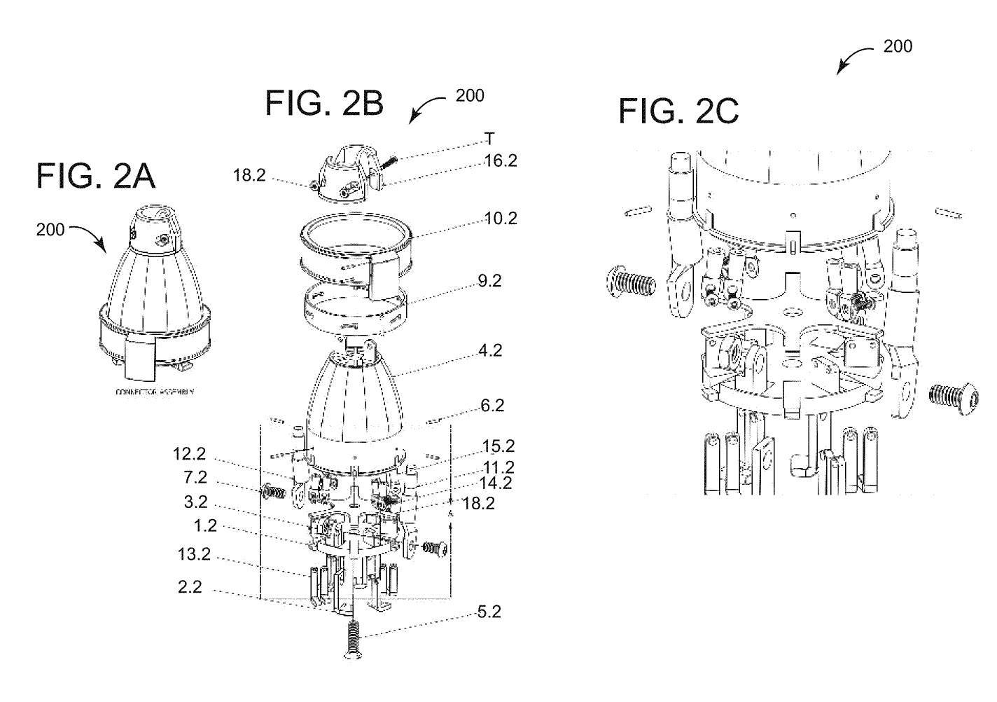

Referring to FIGS. 2A, 2B and 2C, an example of the connector plug assembly 200 is presented. The connector plug may include Main Block, Main Terminal, ¼-20 Thin Hex Nut, Connector Housing, ¼-20×1″ Slotted Flat Head Screw, 1/16″ Steel Dowel Pin, ¼-20×½″ Hex Cap Screw, Spring Plate, Welded Cam Guide, Key Ring, 2AWG Wire Terminal, 18 Awg Male Terminals, 3-48×¼″ Hex Cap Screw, 18 AWG Wire Terminal, Connector Collars, 4-40×⅝″ Hex Cap Screw, 4-40 Stainless Hex Nut

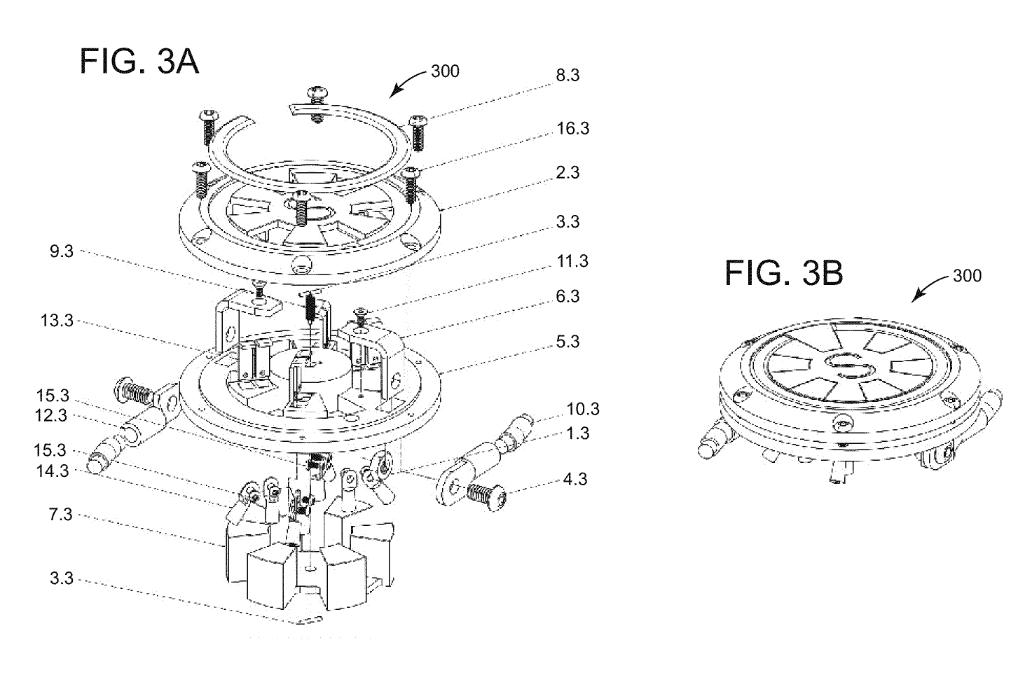

Referring to FIGS. 3A and 3B, an example of the connector base 300 is presented. The connector base 300 may include ¼-20 Thin Hex Nuts, Base Plate, 1/16″ Dowel Pin, ¼-20×½″ Stainless Hex Screw, Base Bracket, Main Terminal, Base Push Cover, LED Ring, Ext. Spring, 2AWG Wire, 3-48×¼″ Stainless Hex Screw, 2AWG Wire Terminal, 18AWG Base Terminal, 18AWG Wire Terminal, 3-48×⅛″ Hex Screw, 8-32×½″ Stainless Torx Screw, 85 mm LED RING.

Referring again to FIGS. 1A and 1B, the example of the charging unit 100 of the electric charging system includes battery spacers 1. The battery spacers 1 position Li-Ion cells 2 in a uniform array for cooling as well as a quick way to connect the cells together via branched connections from cell to cell. The spacers 1 hold the cells 2 in place equidistant from the adjacent cells and provide a rigid structure in the battery frame 7.

The Li-Ion batteries (or cells) 2 provide the energy storage for the charging unit 100. 2) The batteries 2 connect to the charging unit 100 for charging and to the connector 200 for discharging.

A wall charger 3 (such as a Luna Charger) connects 110V wall outlet power to the batteries 2. The charging unit 100 connects to a system of relays to control the sections of batteries 2 which are charged and the rate at which they do so.

A case 4 encloses the batteries 2 and charging unit 100. The case 4 may be a Fibox NEMA Polycarbonate case. The case 4 protects sensitive electronic circuitry within the charging unit 100 from water/moisture.

Battery case brackets (or struts) 5 secure the batteries 2 case 4. The brackets 5 may be a custom fabricated part to fit the hole spacing on the case 4. These brackets are structural components of the assembly that secures the batteries 2 to the NEMA Case 4.

Screw fasteners 6 are used for the structure of the charging unit assembly 100. The screw fasteners, may be thread forming screws and may be designed to create a strong mechanical bond with plastic. These fasteners 6, in this example are used to fasten the Battery Case Strut 5 to the NEMA Case 4.

A battery frame 7 surrounds the battery cell array (or batteries) 2. The frame 7 may be a custom fabricated frame to hold this particular sized battery cell 2 structure. The battery frame 7 holds the battery cell array 2 in place inside the case 4.

Flat heads screws 8 are uses as fasteners for the battery frame. These fasteners attach the battery frame 7 to the battery struts.

Washers 9 are used with screws 8. These washers may provide a non-galling surface for the locknut 10 to rotate against.

Lock nuts 10 are also used with fasteners (or screws) 8. These locknuts hold the Item 8 fasteners to mechanically lock the battery struts to the battery frame.

Pipe fitting 11, in this example is a plastic fitting to provide a hermetic seal for the connector wires. The pipe fitting 11 may be a plastic NPT fitting to provide a water-tight seal on the NEMA case to provide a through hole fitting for the connector cables going to the charger and battery cells.

A plastic sheet 12 directs airflow. This may be a fabricated part to specifically direct the airflow through the battery cell array for cooling purposes. These sheets 12 fit between the batter cells and act as ducting for the air flow to uniformly cool the battery cells. This alleviates any cells from getting too hot and damaging the system.

Cooling fans provide cooling air for the batteries 2. These fans force air through the battery cells cooling them while charging and discharging. The air passes over the heat exchanger 16 on the wall of the case and then returns cooler air to the fan intake.

A heat exchanger sink plate 14 seals holes in the NEMA Case for heat exchanger 16. This may be a fabricated part to provide a water-tight seal on the enclosure. The plate provides a conductive surface for the heat to dissipate through from the heat exchangers.

A heat sink gasket 15 seals the heat sink plate. This is a fabricated part that creates a compliant material for sealing the enclosure. This compliant material allows for the heat exchanger 16 to pass through the case without creating a leak path for water.

A heat exchangers (such as aluminum heat exchangers) 16 dissipate heat from inside the enclosure. The heat exchangers provide thermal conductive paths for the warm air to be cooled through forced convection thus cooling the batteries inside. This allows heat to escape but no water to enter.

Relays 17 control electrical path current flow. The charger unit 100 is designed to charge a plurality of batteries 2 at one time. For example twenty eight cells 2 at a time. Accordingly, the relays 17 control which of the 4 twenty eight cells 2 in the array of cells 2 is being charged at a time.

An adhesive 18, such as a thermal epoxy, is used for the heat exchangers. The thermal epoxy 18 bonds the heat exchangers to the heat exchanger plate while providing a suitable thermally conductive path to cool the inside air.

Referring again to FIGS. 2A, 2B and 2C again, the example of the connector plug assembly 200 includes the following exemplary parts:

Item 1.2) 3D Printed ABS Plastic (Black)

1) This part is the bottom of the connector plug.

2) This is a fabricated piece that is designed to hold the custom connector terminals.

3) This part holds the electric terminals in the correct location and serves as a sealing surface for the connector plug.

Item 2.2) ⅛″ 6061 Aluminum Sheet

1) This is the 2AWG plug terminal for power.

2) This is a fabricated piece that is designed to safely transfer electricity from vehicle to charger as well as wall outlet to charger.

3) This part is the physical connection between the charging cable to the vehicle and the batteries in the charger. The angle is intended so the shielded terminal contacts are connected after turning the connector to the locked position.

Item 3.2) ¼-20 Thin Hex Nut

1) This is the fastener for the 2AWG power terminal.

2) This part attaches to the ¼-20 hex screw which fastens the 2AWG wire terminal to the 2AWG connector terminal.

Item 4.2) 3D Printed ABS Plastic (Black)

1) This is the outer housing for the connector plug.

2) This is a fabricated piece that surrounds the internal plug components and provides a surface for the user to hold on to.

3) This connector housing holds the locking pins and guides the locking key around the plug. It also provides a sealing surface for the connector plug.

Item 5.2) ¼-20×1″ Slotted Flat Head Screw

1) This is the main housing fastener holding the top and bottom sections of the plug together.

2) This fastener threads into the connector housing and holds the plug base plate in place providing the structure for the connector.

Item 6.2) 1/16″ Steel Dowel Pin

1) This part guides the locking plate into place around the connector plug housing.

2) This dowel pin acts like a cam and pushes the locking plate down when the plug is turned and keyed into the correct location.

Item 7.2) ¼-20×½″ Hex Cap Screw

1) This is the fastener for the 2AWG power terminal.

2) This fastener threads into the ¼-20 Hex Nut to hold the 2AWG wire terminal to the 2AWG connector terminal.

Item 8.2) Spring Plate

1) This spring plate maintains the restoring force for the locking plate when it is in the locked position.

2) This is a custom fabricated piece to fit the geometry of the connector plug as well as the locking plate.

3) This piece applies pressure to the locking plate so that when the system is keyed in the correct location and locked the connector can't come loose without the user unlocking the plug.

Item 9.2) Cam Guide

1) This is the locking plate that rotates around the connector housing and locks the connector in when connected to the charger.

2) This is a fabricated plate that is designed to lock at a certain pressure on the spring plate as well as the correct amount of rotation of the connector plug.

3) This plate guide around the dowel pins to lock into position when the connector is keyed into the base. The spring plate applies pressure to this locking plate to ensure the connector is locked until the collar is pressed down and twisted unlocking and disconnecting the connector from the base.

Item 10.2) 3D Printed ABS Plastic (Black)

1) This is the locking collar that attaches to the locking plate and keys into the base.

2) This is a fabricated part that mates to the connector base and the locking plate.

3) The collar provides the user interface to lock and unlock the connector plug with the charger.

Item 11.2) Connected to Chademo Cable

1) This is the 2AWG power cable.

2) This cable transmits positive and negative DC power to and from the charger.

Item 12.2) 2AWG Wire Terminal

1) This terminal connector crimps onto the 2AWG cable and connects the Chademo cable to the connector terminal.

2) This terminal provides the conductive path for the power cables and is the physical connector between the cable and connector terminal.

Item 13.2) Connector Logic Terminals

1) These connector terminals provide the intelligent connection system that the charger cable needs to tell if it's being safely charged.

2) This is a fabricated piece that is designed to safely transfer electricity from vehicle to charger as well as wall outlet to charger.

3) This connector provides the electrical contact between the charger and the charging cable's logic system to charge and discharge safely.

Item 14.2) 3-48×¼″ Hex Cap Screw

1) This fastener holds the 18AWG wire terminal to the 18AWG connector terminal.

2) This parts threads into the connector base and holds the wire terminal and connector terminal together to create the electrical connection.

Item 15.2) 18 AWG Wire Terminal

1) This terminal is the physical connection for the logic wires in the connector cables.

2) This part terminates the 18AWG wire and creates a physical connection to the connector terminal.

Item 16.2) 3D Printed ABS Plastic (Black)

1) This is the cable clamp housing and provides a clamping force on the outside of the cable to keep it from moving out of the connector plug.

2) This is a fabricated piece that is meant to fit the geometry of the charging cable as well as the top of the connector housing.

3) This part has two components that clamp on either side of the cable while also securing to the top of the connector housing to hold the parts together.

Item 17.2) 4-40×⅝″ Hex Cap Screw

1) This part fastens the two cable clamps together.

2) The hex cap screw threads into the corresponding nut to tighten the parts together keeping the parts secure.

Item 18.2) 4-40 Stainless Hex Nut

1) This part fastens the two cable clamps together.

2) The hex nut threads onto the hex cap screw and fits into the geometry of the cable clamp holding the cable in place.

Referring again to FIGS. 3A and 3B, the example of the connector base assembly 300 includes the following exemplary parts:

Item 1.3) ¼-20 Thin Hex Nut

1) This part fastens onto the respective hex cap screw to create the electrical connection between the 2AWG wire terminal and the 2AWG base terminal.

2) This part threads onto the hex cap screw tightening the wire terminal and base terminal together creating an electrical connection.

Item 2.3) 3D Printed ABS Plastic (White)

1) This is the top base plate for the connector base and locates the connector plug terminals in the correct location.

2) This is a fabricated piece that is specific to the geometry of the connector plug.

3) This piece mates with the charger housing and is the outer interface with the connector plug. It locates the connector plug terminals in the correct location by only allowing the connector key to fit into one location.

Item 3.3) 1/16″ Dowel Pin

1) This part acts as a spanner bar to terminate the ends of the extension spring.

2) These parts terminate the extension spring and provide a frame for the spring force to act against keeping the base plate up when the connector plug is not connected.

Item 4.3) ¼-20×½″ Stainless Hex Screw

1) This part fastens to the corresponding hex nut to hold the base terminal and the wire terminals together.

2) This part threads into the hex nut providing the physical connection to make the electrical connection for the 2AWG power.

Item 5.3) 3D Printed ABS Plastic (White)

1) This is the lower base plate which positions all the electrical terminals into place and acts as the fastener for the surface screws.

2) This is a fabricated piece that fits the specific geometry of the connector plug and the respective electrical terminals.

3) This piece holds the electrical terminals in place as well as guides the base place to move in the vertical direction.

Item 6.3) ⅛×½″ Aluminum Bar

1) This is the base terminal the allows the power to be transferred from the batteries to the connector and then to the vehicle.

2) This is a fabricated piece that fits the specific geometry of the connector plug and is sized to pass the required amps to charge.

3) This piece is fastened to the lower base plate as well as the 2AWG wire terminal.

Item 7.3) 3D Printed ABS Plastic (White)

1) This is the base plate which provides a cover for the electrical connections for safety as well as keeping dirt and dust out.

2) This is a custom fabricated piece that fits the specific geometry of the base plate.

3) The base plate is pulled into the up position when the connector plug is not attached to keep dust out. This is done with the restoring force from the extension spring attached to the lower base plate.

Item 8.3) 85 mm LED Ring

1) This is a light indicator to interface with the user to alert them of problems as well as charging status.

2) This piece sits in the channel in the upper base plate and displays the various visual status cues for the user to know how the charger is behaving.

Item 9.3) ⅝″ Steel Extension Spring

1) This is the part that creates the restoring force holding the base plate up to protect the terminals.

2) This piece is terminated on both ends by a dowel pin and holds the base plate up to the upper base plate until the connector plug pushes it down.

Item 10.3) 2AWG Wire Terminal

1) This is the connection between the wire terminal and the batteries in the charger.

2) This wire is terminated by the 2AWG wire terminal and passes the main power voltage for the vehicle.

Item 11.3) #3-48×¼″ Stainless Hex Screw

1) This piece fastens the base terminal to the lower base plate.

2) This piece threads into the lower base plate fastening the base terminal in place.

Item 12.3) 2AWG Wire Terminal

1) This piece terminates the 2AWG cable wire and provides a mechanical connection for the wire.

2) The wire terminal is fastened to the base terminal passing the main power voltage to the vehicle.

Item 13.3) 1/16×½″ Copper Bar

1) This piece is the base terminal that provides the electrical connection to the logic terminals on the connector plug.

2) This is a fabricated piece that fits the geometry of the connector plug logic connections.

3) These pieces fasten to the 18AWG wire terminals and are fastened to the lower base plate.

Item 14.3) 18AWG Wire Terminal

1) This part terminates the 18AWG wires providing the logic connections to safely charge the vehicle.

2) The terminal is fastened to the base logic terminals creating the mechanical connection to pass the electrical logic signals.

Item 15.3) #3-48×⅛″ Hex Screw

1) This part fastens the 18AWG wire terminals to the base logic terminals.

2) The hex screw threads onto the base logic terminal.

Item 16.3) #8-32×½″ Stainless Torx Screw

1) This part fastens into the lower base plate holding the upper and lower base plates together through the charger housing.

2) This part holds the connector base together and fastens it to the charger housing, providing a relatively tamper-free connection that faces the user.

During operation, the charging unit 100, connector plug assembly 200 and connector base assembly 300 of the electric charging system interact as follows:

Connector & EV cable

The connector plug assembly 200 attaches to a Chademo or SAE Combo interface cable allowing for electric vehicle charging. The connector plug assembly 200 houses all 10 necessary wires that handle both power (two 2AWG) and logic (eight 18AWG) transfer between vehicle and charging unit 100. These wires are terminated by crimp terminals allowing for standard fasteners to attach connector plug terminals.

Connector & Connector Base

The connector plug terminals along with the connector key push the connector base plate down revealing a path to the connector base terminals. The user twists the connector housing which places the connector terminals in contact with the base terminals. During the twist of the connector the key ring remains static and the connector housing rotates within it. Pins attached to the housing follow a cam slot in the key ring which pushes the ring against a spring plate until it reaches the locking point. At the locking point the connector plug and base terminals are in contact and the connector is locked in place. The only way for the connector to be unlocked is by pushing on the key ring and twisting the housing. The terminals are no longer in contact and the plug can be removed safely.

Connector Base & Charger

The connector base terminals are connected to wires from the charger through standard fasteners. The charger wires are terminated by crimp connections and lead to the charging system. The connector base prevents dust from entering the charging system area through the spring loaded base plate. This feature also protects the user from accidental shock from touching the base terminals.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. An electrical vehicle charging system, comprising:
a connector plug connectable to a connector base connected to a modular charging unit;
said connector plug comprising a plurality of connectors receivable in a plurality of openings of said connector base;
a connector of said plurality of connectors comprising an extending portion for contacting a terminal connector of said connector base;
said connector plug and said connector base rotatable relative to each other after said plurality of connectors are received in said plurality of openings such that said extending portion rotates to contact said terminal connector to provide an electrical connection between said modular charging unit and a load of an electric vehicle;
said connector plug and said connector base lockable relative to each other to inhibit movement therebetween after said extending portion contacts said terminal connector.

2. The electrical vehicle charging system of claim 1 wherein said plurality of openings comprise a plurality of connector guards biased upwardly to fill the openings when the plurality of connectors are removed therefrom, said plurality of connector guards configured to inhibit foreign material from entering said plurality of openings.
